(19) United States
(12) Patent Application Publication
(10) Pub. No.: US 2015/0058801 A1
(43) Pub. Date: Feb. 26, 2015

(54) MULTI-TOUCH INSPECTION TOOL

(71) Applicant: General Electric Company, Schenectady, NY (US)

(72) Inventors: Justin Varkey John, Cohoes, NY (US); Robert William Grubbs, Blue Ridge, VA (US)

(73) Assignee: General Electric Company, Schenectady, NY (US)

(21) Appl. No.: 13/974,138

(22) Filed: Aug. 23, 2013

(51) Int. Cl. G06F 3/0488; G06F 17/24; G06F 17/21; G06F 3/0484

(52) U.S. Cl. CPC G06F 3/0488; G06F 3/04847; G06F 17/245; G06F 17/211
USPC 715/801

(57) ABSTRACT

One aspect of the invention is a system for providing a multi-touch inspection tool. The system includes a multi-touch display and processing circuitry configured to display an inspection tool for a chart on a user interface on the multi-touch display. The inspection tool includes a multiplier-scale control and a precision control. The processing circuitry is also configured to determine a base level of scaling to apply to the chart based on a current value of the multiplier-scale control and detect a touch-based input on the precision control for a precision adjustment of the chart. The precision adjustment is based on linear steps dynamically defined with respect to the base level of scaling. The chart is adjusted in response to the touch-based input on the precision control as a combination of the base level of scaling determined by the multiplier-scale control and the precision adjustment of the precision control.

### BACKGROUND OF THE INVENTION

The subject matter disclosed herein relates to computer system user interfaces, and more particularly, to an inspection tool for a multi-touch computer system.

When viewing a large quantity of data on a chart, varying levels of granularity may be desired. Identifying trends in data can be performed with respect to different time scales. For example, data samples collected one or more times per second can accumulate over hours, days, weeks, months, and years. Patterns may not be discernible when the data is viewed on an hourly basis but can become apparent when viewed over the course of multiple months. Other trends may appear as a pattern at a certain time of day or day of the week. Data analysts may also desire to zoom in to look at data values surrounding particular events, as well as add or remove signals under analysis to assist in determining causal relationships.

Computer mouse-based tools for viewing data charts and trends may include zoom controls to change scaling in conjunction with keyboard-based data entry. A combination of mouse clicks and typing in specific desired numerical ranges can be used to customize granularity for viewing data; however, this is typically a slow and cumbersome process. In touch-based user interfaces, a pinch-zoom gesture is often used to zoom in and out. Pinch-zoom gestures can be effective for rescaling a particular view but do not typically provide the desired level of precision for trend analysis.

### BRIEF DESCRIPTION OF THE INVENTION

One aspect of the invention is a system for providing a multi-touch inspection tool. The system includes a multi-touch display and processing circuitry coupled to the multi-touch display. The processing circuitry is configured to display an inspection tool for a chart on a user interface on the multi-touch display. The inspection tool includes a multiplier-scale control and a precision control. The processing circuitry is also configured to determine a base level of scaling to apply to the chart based on a current value of the multiplier-scale control. The multiplier-scale control defines steps between multiplier-scaling values. The processing circuitry is further configured to detect a touch-based input on the precision control for a precision adjustment of the chart. The precision adjustment is based on linear steps dynamically defined with respect to the base level of scaling. The chart is adjusted in response to the touch-based input on the precision control as a combination of the base level of scaling determined by the multiplier-scale control and the precision adjustment of the precision control.

Another aspect of the invention is a method for providing a multi-touch inspection tool. The method includes displaying an inspection tool for a chart on a user interface on a multi-touch display. The inspection tool includes a multiplier-scale control and a precision control. The method also includes determining, by processing circuitry coupled to the multi-touch display, a base level of scaling to apply to the chart based on a current value of the multiplier-scale control. The multiplier-scale control defines steps between multiplier-scaling values. The method further includes detecting, by the processing circuitry, a touch-based input on the precision control for a precision adjustment of the chart. The precision adjustment is based on linear steps dynamically defined with respect to the base level of scaling. The method additionally includes adjusting the chart, by the processing circuitry, in response to the touch-based input on the precision control as a combination of the base level of scaling determined by the multiplier-scale control and the precision adjustment of the precision control.

Another aspect of the invention is a computer program product for providing a multi-touch inspection tool. The computer program product includes a non-transitory computer readable medium storing instructions for causing processing circuitry coupled to a multi-touch display to implement a method. The method includes displaying an inspection tool for a chart on a user interface on the multi-touch display. The inspection tool includes a multiplier-scale control and a precision control. A base level of scaling to apply to the chart is determined based on a current value of the multiplier-scale control. The multiplier-scale control defines steps between multiplier-scaling values. A touch-based input is detected on the precision control for a precision adjustment of the chart. The precision adjustment is based on linear steps dynamically defined with respect to the base level of scaling. The chart is adjusted in response to the touch-based input on the precision control as a combination of the base level of scaling determined by the multiplier-scale control and the precision adjustment of the precision control.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a block diagram of multi-touch computer system including a multi-touch display;

FIG. 2 depicts an example of a user interface on the multi-touch display of FIG. 1;

FIG. 3 depicts an example of a multi-touch inspection tool defined as a zoom control on the user interface of FIG. 2;

FIG. 4 depicts a detailed view of the multi-touch inspection tool of FIG. 3;

FIG. 5 depicts an example chart of a signal having an initial scaling;

FIG. 6 depicts an example chart of the signal of FIG. 5 having a first multiplier adjusted scaling;

FIG. 7 depicts an example chart of the signal of FIG. 5 having a second multiplier adjusted scaling;

FIG. 8 depicts an example chart of the signal of FIG. 5 having a linearly adjusted scaling relative to FIG. 7;

FIG. 9 depicts a detailed view of a multi-touch inspection tool formatted as a pan control; and

FIG. 10 depicts a process for providing a multi-touch inspection tool in accordance with exemplary embodiments.

The detailed description explains embodiments of the invention, together with advantages and features, by way of example with reference to the drawings.

### DETAILED DESCRIPTION OF THE INVENTION

Exemplary embodiments provide an inspection tool for a multi-touch display. The inspection tool is configured to provide a base level of scaling defined by multiplier steps and precision adjustments as linear steps dynamically defined with respect to the base level of scaling. The inspection tool is configured to detect scaling change requests as touch-based gestures or movements. The inspection tool is sized such that multiplier-scaling values and precision adjustment requests can be provided by separate fingers of a same user hand without typing in specific numerical values for scaling adjustments. Accordingly, a user may perform rescaling by multiplier factors in combination with precise linear adjustments on the inspection tool at about the same time by making a combination of gestures using the same hand.

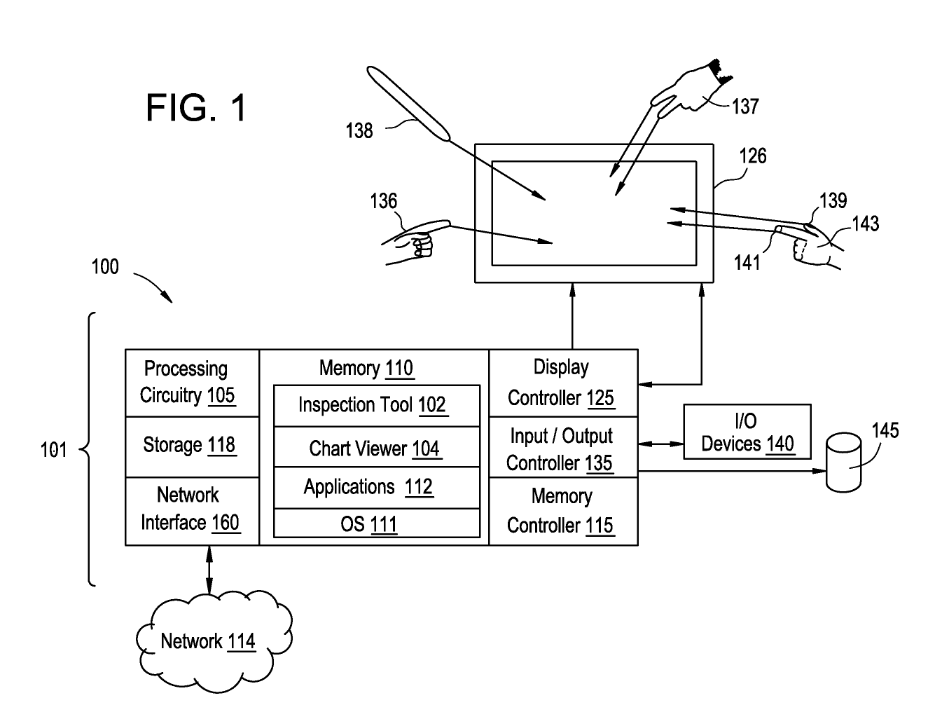

FIG. 1 illustrates an exemplary embodiment of a multi-touch computer system 100 that can be implemented as a touch-sensitive computing device as described herein. The multi-touch computer system 100 can be utilized in a variety of environments such as a control system for controlling processes, plants such as power production plants, and other environments known in the art. The methods described herein can be implemented in software (e.g., firmware), hardware, or a combination thereof. In exemplary embodiments, the methods described herein are implemented in software, as one or more executable programs, and executed by a special or general-purpose digital computer, such as a personal computer, mobile device, workstation, minicomputer, or mainframe computer operably coupled to or integrated with a multi-touch display. The multi-touch computer system 100 therefore includes a processing system 101 interfaced to a multi-touch display 126. The multi-touch display 126 can display text and images, as well as recognize the presence of one or more points of contact as input.

In exemplary embodiments, in terms of hardware architecture, as shown in FIG. 1, the processing system 101 includes processing circuitry 105, memory 110 coupled to a memory controller 115, and one or more input and/or output (I/O) devices 140, 145 (or peripherals) that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the input/output controller 135 may include address, control, and/or data connections to enable appropriate communications among the aforementioned components. The processing system 101 can further include a display controller 125 coupled to the multi-touch display 126. The display controller 125 may drive output to be rendered on the multi-touch display 126.

The processing circuitry 105 is hardware for executing software, particularly software stored in memory 110. The processing circuitry 105 can include any custom made or commercially available processor, a central processing unit (CPU), an auxiliary processor among several processors associated with the processing system 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, memory card, programmable read only memory (PROM), tape, compact disc read only memory (CD-ROM), digital versatile disc (DVD), disk, diskette, cartridge, cassette or the like, etc.). Moreover, the memory 110 may incorporate electronic, magnetic, optical, and/or other types of storage media. The memory 110 can have a distributed architecture, where various components are situated remote from one another but can be accessed by the processing circuitry 105.

Software in memory 110 may include one or more separate programs, each of which includes an ordered listing of executable instructions for implementing logical functions. In the example of FIG. 1, the software in memory 110 includes an inspection tool 102, a chart viewer 104, a suitable operating system (OS) 111, and various applications 112. The OS 111 essentially controls the execution of computer programs, such as various modules as described herein, and provides scheduling, input-output control, file and data management, memory management, communication control and related services. Various user interfaces can be provided by the OS 111, the inspection tool 102, the chart viewer 104, the applications 112, or a combination thereof. The inspection tool 102 can process touch-based inputs received via the multi-touch display 126 and control rescaling of charts displayed by the chart viewer 104 in response to the touch-based inputs as further described herein.

The inspection tool 102 may be implemented in the form of a source program, executable program (object code), script, or any other entity comprising a set of instructions to be performed. When a source program, then the program may be translated via a compiler, assembler, interpreter, or the like, which may or may not be included within the memory 110, so as to operate properly in conjunction with the chart viewer 104, the OS 111 and/or the applications 112. Furthermore, the inspection tool 102 can be written in an object oriented programming language, which has classes of data and methods, or a procedure programming language, which has routines, subroutines, and/or functions.

In exemplary embodiments, the input/output controller 135 receives touch-based inputs from the multi-touch display 126 as detected touches, gestures, and/or movements. The multi-touch display 126 can detect input from one finger 136, multiple fingers 137, a stylus 138, and/or other sources (not depicted). The multiple fingers 137 can include a thumb 139 in combination with another finger 141, such as an index finger, on a same user hand 143. Multiple inputs can be received contemporaneously or sequentially from one or more users. In one example, the multi-touch display 126 includes infrared (IR) sensing capabilities to detect touches, shapes, and/or scannable code labels.

Other output devices such as the I/O devices 140, 145 may include input or output devices, for example but not limited to a printer, a scanner, a microphone, speakers, a secondary display, and the like. The I/O devices 140, 145 may further include devices that communicate both inputs and outputs, for instance but not limited to, components of a wireless interface such as a network interface card (NIC) or modulator/demodulator (for accessing other files, devices, systems, or a network), a radio frequency (RF) or other transceiver, a telephonic interface, a bridge, a router, a mobile device, a portable memory storage device, and the like.

In exemplary embodiments, the system 100 can further include a network interface 160 for coupling to a network 114. The network 114 can be an IP-based network for communication between the processing system 101 and any external server, client and the like via a broadband connection. The network 114 transmits and receives data between the processing system 101 and external systems. In exemplary embodiments, network 114 can be a managed IP network administered by a service provider. The network 114 may be implemented in a wireless fashion, e.g., using wireless protocols and technologies, such as WiFi, WiMax, etc. The network 114 can also be a packet-switched network such as a local area network, wide area network, metropolitan area network, Internet network, or other similar type of network environment. The network 114 may be a fixed wireless network, a wireless local area network (LAN), a wireless wide area network (WAN), a personal area network (PAN), a virtual private network (VPN), intranet or other suitable network system and includes equipment for receiving and transmitting signals.

If the processing system 101 is a PC, workstation, intelligent device or the like, software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the processing system 101 is activated.

When the processing system 101 is in operation, the processing circuitry 105 is configured to execute software stored within the memory 110, to communicate data to and from the memory 110, and to generally control operations of the processing system 101 pursuant to the software. The inspection tool 102, the chart viewer 104, the OS 111, and the applications 112 in whole or in part, but typically the latter, are read by the processing circuitry 105, perhaps buffered within the processing circuitry 105, and then executed.

When the systems and methods described herein are implemented in software, as is shown in FIG. 1, the methods can be stored on any computer readable medium, such as storage 118, for use by or in connection with any computer related system or method.

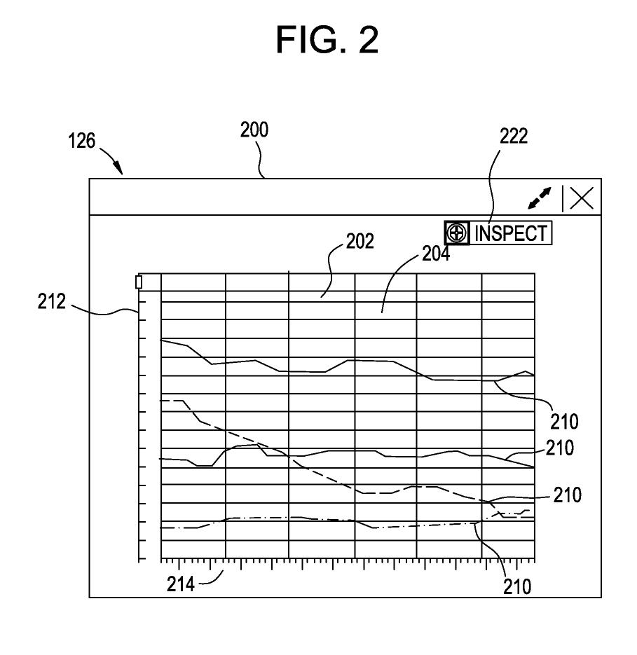

FIG. 2 depicts an example of a user interface 200, which is interactively displayed on the multi-touch display 126 of FIG. 1. In the example of FIG. 2, the user interface 200 is an embodiment of the chart viewer 104 of FIG. 1 that is configured to display data for trend identification and detailed analysis. The user interface 200 may display a variety of text and graphics on the multi-touch display 126. The user interface 200 may be generated by the processing circuitry 105 of FIG. 1 executing the chart viewer 104 of FIG. 1. The user interface 200 is configured to receive touch-based inputs on the multi-touch display 126 and respond thereto.

In the example of FIG. 2, the user interface 200 displays a chart 202 as a graphical representation of data for at least one signal 210 on the multi-touch display 126. The chart 202 depicts a signal view over a period of time on a data display portion 204 of the chart 202. A value scale 212 and a time scale 214 can also be displayed as axes on the chart 202. The user interface 200 may also include an inspect icon 222 that launches the inspection tool 102 of FIG. 1 to enable rapid changes in scaling of the chart 202 and can also provide detailed data value information. Additional features can also be included on the user interface 200 and chart 202, as FIG. 2 is merely one example.

The inspection tool 102 of FIG. 1 is operable as a zoom control on the data display portion 204 of the chart 202. A zoom control can change a viewable level of detail displayed on the chart 202 and increase displayed granularity on the time scale 214. The inspection tool 102 of FIG. 1 may also be operable as a pan control to rescale of an interval of movement to shift data selected for display on the chart 202. Shifting of data advances the time scale 214 forward or back to view the at least one signal 210 at a different point in time without changing the displayed granularity on the time scale 214.

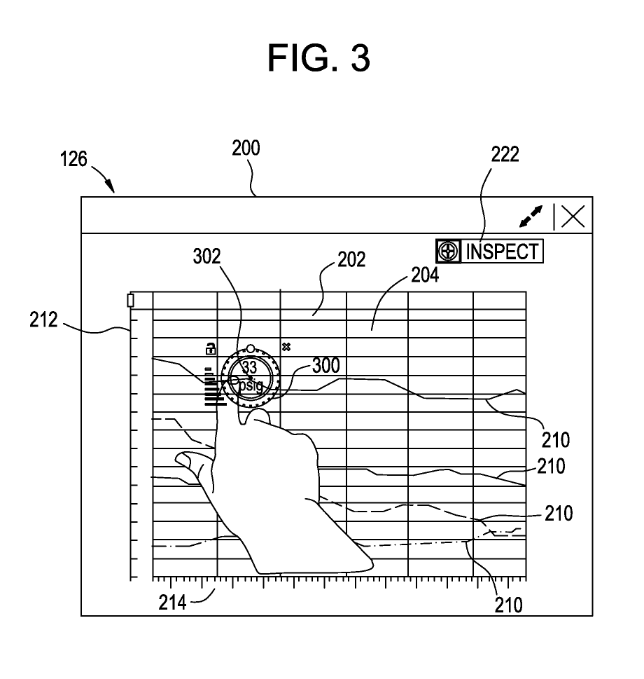

FIG. 3 depicts an example of a zoom control 300 graphically displayed on the user interface 200 of FIG. 2 as an embodiment of the inspection tool 102 of FIG. 1 positioned over the data display portion 204 of the chart 202. The zoom control 300 is an embodiment of a multi-touch inspection tool that is responsive to touch-based inputs on the multi-touch display 126. When a user desires to launch the zoom control 300, the user can apply a particular gesture on the multi-touch display 126, such as a letter “Z” motion on the data display portion 204 of the chart 202, for example. Alternatively, launching of the zoom control 300 can be based on touching of icon, such as the inspect icon 222. The zoom control 300 can track to a particular signal 210. Based on a current location 302 of the zoom control 300, a data value of the underlying signal 210 may be displayed. When the inspection tool is a zoom control, such as zoom control 300 of FIG. 3, the inspection tool performs rescaling to change a viewable level of detail displayed on the chart 202.

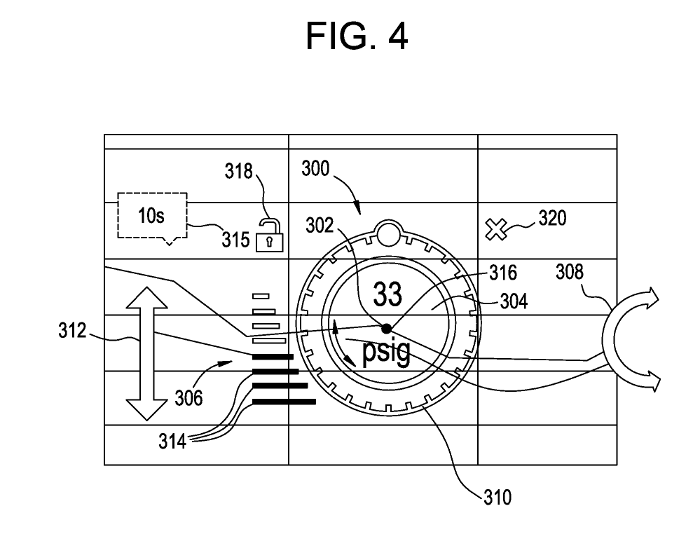

FIG. 4 depicts a detailed view of the zoom control 300 of FIG. 3. The zoom control 300, as a type of inspection tool 102 of FIG. 1, may include a dial control 304 for precision adjustment and a slider control 306 for setting a base level of scaling. Accordingly, the dial control 304 may also be referred to as a precision control 304, and the slider control 306 may also be referred to as a multiplier-scale control 306. The multiplier-scale control 306 defines steps between multiplier-scaling values, and the precision control 304 makes precision adjustments based on linear steps dynamically defined with respect to the base level of scaling.

The dial control 304 is responsive to a dial turning gesture 308 that can be detected on the multi-touch display 126. Applying the dial turning gesture 308 to the dial control 304 in a clockwise or counter-clockwise direction results in a linear ratio change of the chart 202 of FIG. 3 in relation to the base level of scaling established by the slider control 306. For example, if the chart 202 is configured to display a ten second period of data, rotating the dial control 304 can reduce the display period in linear steps, such as nine seconds, eight seconds, seven seconds, six seconds, and so forth, down to one second in this example in order to slowly increase granularity of viewed data. Rotating the dial control 304 in an opposite direction can increase the display period in linear steps, such as by additional one second increments. The dial control 304 may also have associated graduation marks 310 to indicate a number and position of steps for linear zooming. The dial turning gesture 308 can be applied to the dial control 304 for greater than one complete revolution to continue zooming for multiple revolutions of the dial control 304.

The slider control 306 is responsive to a sliding gesture 312 that can be detected on the multi-touch display 126. Applying the sliding gesture 312 to the slider control 306 in an up-down motion results in a ratio change to the base level of scaling for the dial control 304. For example, if the chart 202 of FIG. 3 is configured to display a ten second period of data, sliding the slider control 306 can change the base level of scaling by factors of ten, such as down to one second or 1/10 second, or up to 100 seconds, 1000 seconds, and so forth. As another example, sliding the slider control 306 can change the base level of scaling by various multiplier units, such as milliseconds, seconds, minutes, hours, days, weeks, and so forth. The slider control 306 may include a series of discrete steps 314, displayed as bars in this example, that are each configured to adjust the base level of scaling used for the dial control 304 by a multiplier.

As can be seen in FIG. 4, the dial control 304 and the slider control 306 are closely spaced in proximity to support applying touch-based inputs using a same user hand 143 of FIG. 1 at about the same time. For instance, a user can apply a the sliding gesture 312 using thumb 139 of FIG. 1 to quickly make base level of scaling adjustments and then in rapid succession use another finger 141 of FIG. 1, such as an index finger, to make precision adjustments on the dial control 304 such that displayed granularity on the time scale 214 of FIG. 3 also changes rapidly. In one embodiment, the dial control 304 and the slider control 306 are less than six inches (15.24 cm) apart. Although the example of FIG. 4 depicts the slider control 306 positioned to the left of the dial control 304, other configurations can be supported. For example, the zoom control 300 or inspection tool 102 of FIG. 1 may be configurable to support left-handed users by positioning the slider control 306 to the right of the dial control 304. Alternatively, the slider control 306 may be positioned above or below the dial control 304. As a further alternative, the dial control 304 can be configured to support base level of scaling adjustments and the slider control 306 can be configured to support precision adjustments.

The zoom control 300 may also provide relative zoom level feedback using, for instance, a temporary popup indication such as a tooltip 315. The tooltip 315 can appear for a brief period of time during and/or after scaling adjustments to inform the user of a current base level of scaling. The zoom control 300 may also include a value viewer 316 configured to display a data value associated with the current location 302 of the zoom control 300. Tapping the value viewer 316 can enable displaying of the data value associated with the current location 302. The zoom control 300 can also include a lock/unlock control 318 configured to prevent movement of the zoom control 300 when locked and to allow movement of the zoom control 300 when unlocked. A close command 320 can be included on the zoom control 300 to remove the zoom control 300 from the user interface 200 of FIG. 3. In one embodiment, the data value displayed by the value viewer 316 remains persistently displayed on the chart 202 of FIG. 3 after closing the zoom control 300. It will be understood that other commands can also be added to the zoom control 300, such as an auto-scale command (not depicted).

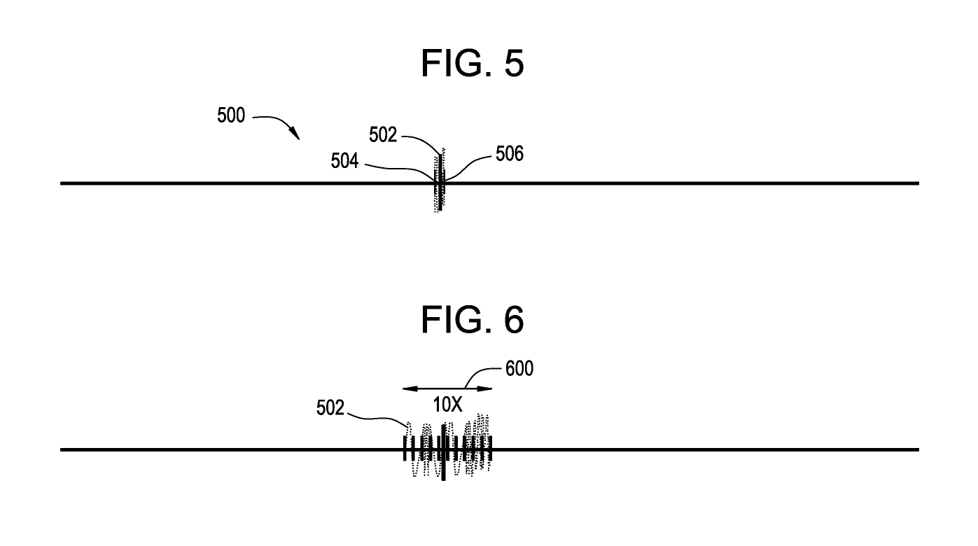

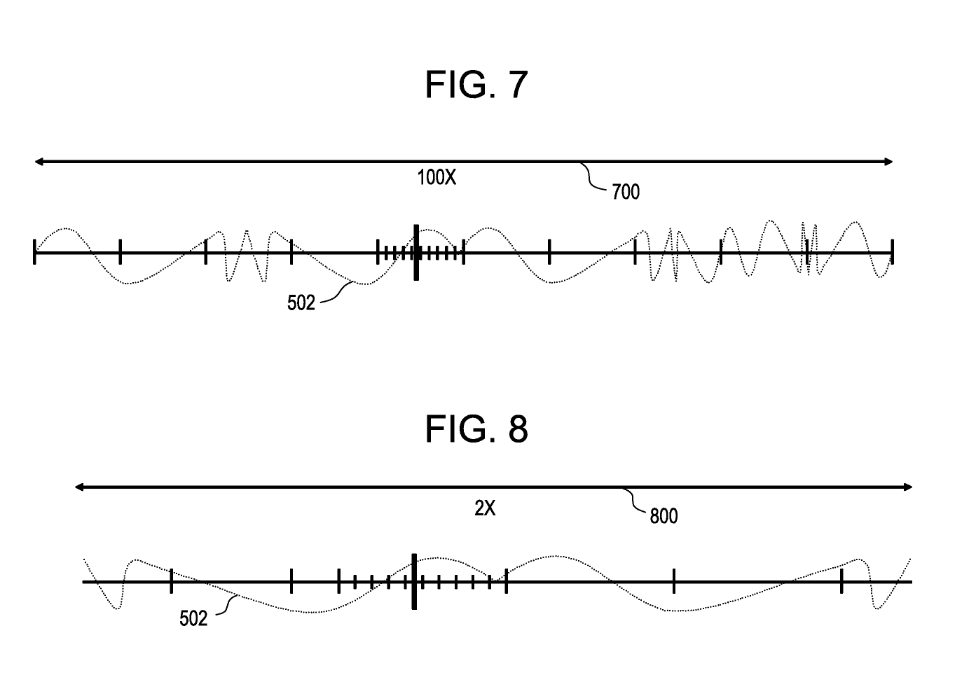

FIG. 5 depicts an example chart 500 of a signal 502 having an initial base level of scaling between times 504 and 506. The chart 500 is representative of a portion of the chart 202 of FIG. 3. Applying an embodiment of the inspection tool 102 of FIG. 1, such as the zoom control 300 of FIG. 4, a user can perform multiplier rescaling of the base level of scaling using the slider control 306 of FIG. 4. A first multiplier adjustment 600 may rescale the base level of scaling for the signal 502 such that an initial application of the dial turning gesture 308 of FIG. 4 to the dial control 304 of FIG. 4 starts zooming by a factor of ten as depicted in FIG. 6. The user may decide that a greater degree of zooming is needed and continue with the sliding gesture 312 of FIG. 4 on the slider control 306 of FIG. 4 in combination with the dial turning gesture 308 of FIG. 4 on the dial control 304 of FIG. 4 to make a second multiplier adjustment 700 as depicted in FIG. 7 to rescale the signal 502 by another factor of ten relative to FIG. 6, or a one hundred times zoom in relative to FIG. 5. To make a further precision adjustment relative to FIG. 7, the user can continue to apply the dial turning gesture 308 of FIG. 4 to the dial control 304 of FIG. 4, to make a linear adjustment 800 of FIG. 8, which is a two times adjustment relative to FIG. 7 in this example. Other nonbase-10 multiplier factors can also be supported.

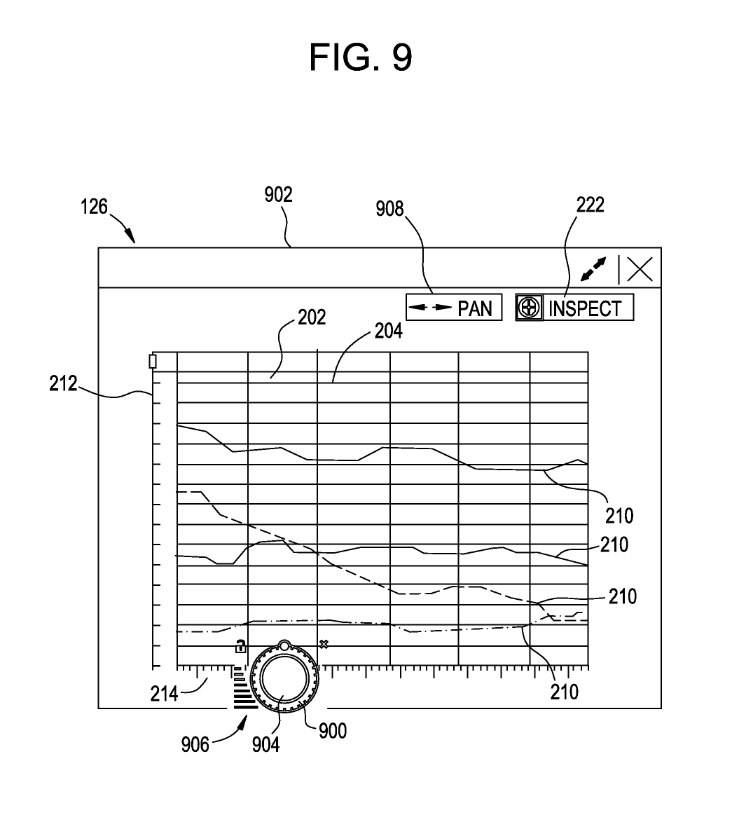

FIG. 9 depicts a detailed view of a multi-touch inspection tool, such as inspection tool 102 of FIG. 1, formatted as a pan control 900 displayed on a user interface 902 on the multi-touch display 126. The user interface 902 is similar to the user interface 200 of FIG. 2 and includes the chart 202 with data display portion 204, at least one signal 210, value scale 212, and time scale 214. The user interface can include inspect icon 222 and a pan icon 908. The inspect icon 222 launches the inspection tool 102 of FIG. 1, which may be initially positioned on the data display portion 204 and formatted as the zoom control 300 of FIG. 3. Thus, the inspect icon 222 can alternatively be labeled as “zoom”. The pan icon 908 can launch the inspection tool 102 of FIG. 1, which may be initially positioned on the time scale 214 and formatted as pan control 900. If the pan control 900 is moved back over the data display portion 204, it can be dynamically redefined as the zoom control 300 of FIG. 3. Similarly, moving the zoom control 300 of FIG. 3 from the data display portion 204 to the time scale 214 may dynamically redefine it to be the pan control 900, where the time scale 214 is an axis of the chart 202. As a further alternative, the pan control 900 can be launched by applying a particular gesture on the multi-touch display 126, such as a letter “P” motion, for example.

Similar to the zoom control 300 of FIG. 4, the pan control 900 includes a dial control 904 and a slider control 906. The dial control 904 may also be referred to as a precision control 904, and the slider control 906 may also be referred to as a multiplier-scale control 906. The multiplier-scale control 906 defines steps between multiplier-scaling values, and the precision control 904 makes precision adjustments based on linear steps dynamically defined with respect to the base level of scaling. Rather than adjusting the displayed granularity of the time scale 214, the pan control 900 rescales an interval of movement to shift data selected for display on the chart 202. For example, using the slider control 906 to set a base level of scaling at 10 seconds, and rotating the dial control 904 may result in the at least one signal 210 shifting in time at intervals of about 10 seconds. A clockwise motion applied to the dial control 904 may shift to later times and a counter-clockwise motion applied to the dial control 904 may shift to earlier times. The multiplier scale of the slider control 906 enables rapid transitions between large jumps in time when panning, e.g., 10 seconds, 100 seconds, 1,000 seconds, 10,000 seconds, etc., to relatively small jumps in time, e.g., 1 second, 1/10 second, etc. Rather than logarithmic (i.e., base-10) changes in scale, the multiplier scale of the slider control 906 can be defined in terms of unit scaling, such as milliseconds, seconds, minutes, hours, days, weeks, months, years, etc.

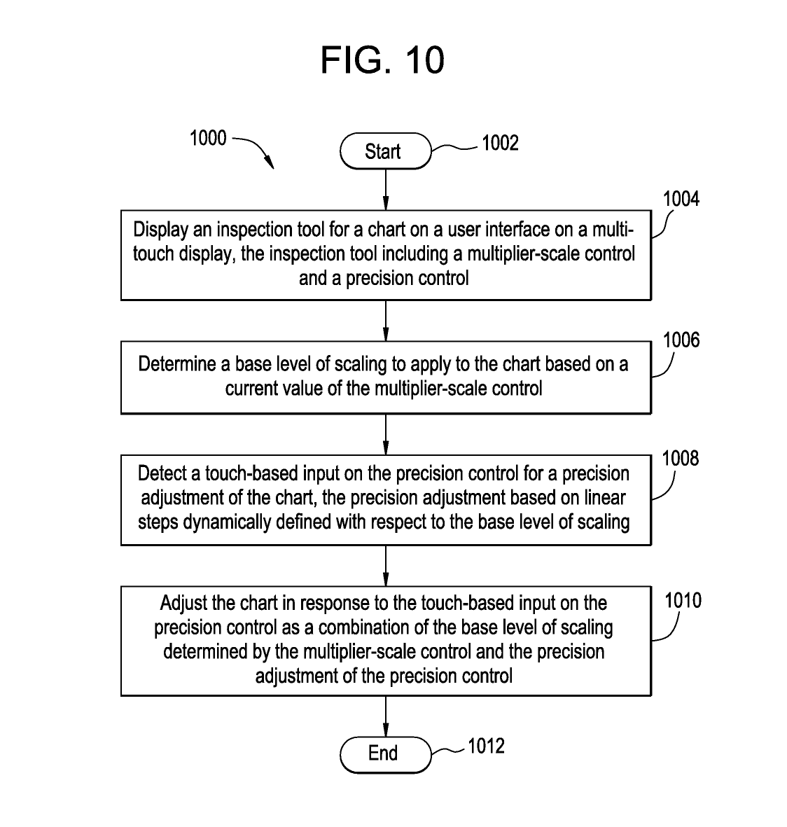

FIG. 10 depicts a process 1000 for providing a multi-touch inspection tool in accordance with exemplary embodiments. The process 1000 is described in reference to FIGS. 1-10. The processing circuitry 105 of FIG. 1 may run the chart viewer 104 of FIG. 1 to display a user interface, such as the user interface 200 of FIGS. 2 and 3 or the user interface 902 of FIG. 9. The processing circuitry 105 is further configured to launch the inspection tool 102 of FIG. 1 based on one or more of: a detected gesture on the multi-touch display 126 of FIG. 1 and a detected touch of an icon, such as icon 222 of FIGS. 2, 3, and 9 or icon 908 of FIG. 9, on the multi-touch display 126. The inspection tool 102 may be embodied as the zoom control 300 of FIGS. 3 and 4 and/or as the pan control 900 of FIG. 9.

The process 1000 begins at block 1002 and transitions to block 1004. At block 1004, the processing circuitry 105 displays the inspection tool 102 of FIG. 1, which can be embodied as the zoom control 300 of FIG. 3 for a chart 202 of FIG. 3 on the user interface 200 on the multi-touch display 126. As depicted in FIGS. 2 and 3, the chart 202 may include a graphical representation of data for at least one signal 210. The inspection tool 102 includes a multiplier-scale control and a precision control, such as the multiplier-scale control 306 and the precision control 304 of the zoom control 300 of FIG. 4 or the multiplier-scale control 906 and the precision control 904 of the pan control 900 of FIG. 9.

At block 1006, the processing circuitry 105 determines a base level of scaling to apply to the chart 202 based on a current value of the multiplier-scale control 306, 906. The multiplier-scale control 306, 906 defines steps between multiplier-scaling values, such as the series of discrete steps 314 of FIG. 4. Changes to the multiplier-scale control 306, 906 result in changes to the base level of scaling.

At block 1008, the processing circuitry 105 detects a touch-based input on the precision control 304, 904 for a precision adjustment of the chart 202. The precision adjustment is based on linear steps dynamically defined with respect to the base level of scaling.

At block 1010, the processing circuitry 105 adjusts the chart 202 in response to the touch-based input on the precision control 304, 904 as a combination of the base level of scaling determined by the multiplier-scale control 306, 906 and the precision adjustment of the precision control 304, 904. The process 1000 ends at block 1012.

The blocks of process 1000 need not be performed in the exact sequence as depicted in FIG. 10. For example, the base level of scaling can be determined after detecting a touch-based input on the precision control 304, 904.

Multiple instances of the process 1000 can operate in parallel such that multiple instances of the inspection tool 102 can be contemporaneously displayed including both the zoom control 300 and the pan control 900, where the processing circuitry 105 of FIG. 1 is configured to render one or more additional inspection tools 102 on the multi-touch display 126. Multiple zoom controls 300 can be useful for inspecting precise values on different signals 210 of FIG. 3 at the same time. Using the pan control 900 at the same time enables rapid examination of varying positions in time while also rapidly changing displayed granularity of the data via zoom control 300.

In exemplary embodiments, a technical effect is providing rescaling of a chart using an inspection tool on a multi-touch display. Supporting a multiplier-scale base level of scaling in combination with precision adjustment based on linear steps dynamically defined with respect to the base level of scaling enables rapid view modification when zooming or panning to identify trends and relationships between multiple signals displayed on a chart of a user interface. The signals can be, for example, related to operation of a power plant or other physical system. While the inspection tool is described relative to a chart of signals, the term “chart” as used herein can refer to any type of a graph, image, flowchart or any displayable data comprising at least two dimensions. For example, the inspection tool can be used on a map, an image viewer, or a graphical software development tool.

As will be appreciated by one skilled in the art, aspects of the present invention may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized including a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contains, or stores a program for use by or in connection with an instruction execution system, apparatus, or device.

Program code embodied on a computer readable medium as a non-transitory computer program product may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the inspection tool 102 of FIG. 1 is implemented in hardware, the methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While the invention has been described in detail in connection with only a limited number of embodiments, it should be readily understood that the invention is not limited to such disclosed embodiments. Rather, modifications can incorporate any number of variations, alterations, substitutions or equivalent arrangements not heretofore described, but which are commensurate with the spirit and scope of the invention. Additionally, while various embodiments have been described, it is to be understood that aspects may include only some of the described embodiments. Accordingly, the invention is not to be seen as limited by the foregoing description, but is only limited by the scope of the appended claims.

1. A system for providing a multi-touch inspection tool, the system comprising:
a multi-touch display; and
processing circuitry coupled to the multi-touch display, the processing circuitry configured to:
display an inspection tool for a chart on a user interface on the multi-touch display, the inspection tool comprising a multiplier-scale control and a precision control;
determine a base level of scaling to apply to the chart based on a current value of the multiplier-scale control, the multiplier-scale control defining steps between multiplier-scaling values;
detect a touch-based input on the precision control for a precision adjustment of the chart, the precision adjustment based on linear steps dynamically defined with respect to the base level of scaling; and
adjust the chart in response to the touch-based input on the precision control as a combination of the base level of scaling determined by the multiplier-scale control and the precision adjustment of the precision control.

2. The system according to claim 1, wherein the multiplier-scale control is a slider control and the precision control is a dial control.

3. The system according to claim 2, wherein the touch-based input comprises a dial turning gesture detected on the dial control.

4. The system according to claim 2, wherein the slider control comprises a series of discrete steps each configured to adjust the base level of scaling, and the processing circuitry is further configured to detect adjustments to the base level of scaling in response to a touch-based input on the slider control.

5. The system according to claim 2, wherein the dial control and the slider control are closely spaced in proximity to support applying touch-based inputs to the dial control and the slider control using a same user hand at about a same time.

6. The system according to claim 1, wherein the inspection tool is a zoom control, and adjustment of the chart comprises rescaling to change a viewable level of detail displayed on the chart.

7. The system according to claim 1, wherein the inspection tool is a pan control, and adjustment of the chart comprises rescaling of an interval of movement to shift data selected for display on the chart.

8. The system according to claim 6, wherein the processing circuitry is further configured to:
determine a position of the inspection tool;
define the inspection tool as the zoom control based on determining that the inspection tool is positioned on a data display portion of the chart; and
dynamically redefine the inspection tool as a pan control based on determining that the inspection tool is positioned on an axis of the chart.

9. A method for providing a multi-touch inspection tool, the method comprising:
displaying an inspection tool for a chart on a user interface on a multi-touch display, the inspection tool comprising a multiplier-scale control and a precision control;
determining, by processing circuitry coupled to the multi-touch display, a base level of scaling to apply to the chart based on a current value of the multiplier-scale control, the multiplier-scale control defining steps between multiplier-scaling values;
detecting, by the processing circuitry, a touch-based input on the precision control for a precision adjustment of the chart, the precision adjustment based on linear steps dynamically defined with respect to the base level of scaling; and
adjusting the chart, by the processing circuitry, in response to the touch-based input on the precision control as a combination of the base level of scaling determined by the multiplier-scale control and the precision adjustment of the precision control.

10. The method according to claim 9, further comprising:
displaying the precision control as a dial control on the inspection tool; and
displaying the multiplier-scale control as a slider control on the inspection tool.

11. The method according to claim 10, further comprising:
detecting a dial turning gesture on the dial control as the touch-based input.

12. The method according to claim 10, further comprising:
displaying the slider control as a series of discrete steps each configured to adjust the base level of scaling of the chart; and
detecting adjustments to the base level of scaling in response to a touch-based input on the slider control.

13. The method according to claim 10, further comprising:
positioning the dial control and the slider control in closely spaced proximity to support applying touch-based inputs to the dial control and the slider control using a same user hand at about a same time.

14. The method according to claim 9, wherein the inspection tool is a zoom control, and adjustment of the chart comprises rescaling to change a viewable level of detail displayed on the chart.

15. The method according to claim 9, further comprising:
determining a position of the inspection tool;
defining the inspection tool as a zoom control based on determining that the inspection tool is positioned on a data display portion of the chart; and
dynamically redefining the inspection tool as a pan control based on determining that the inspection tool is positioned on an axis of the chart.

16. A computer program product for providing a multi-touch inspection tool, the computer program product including a non-transitory computer readable medium storing instructions for causing processing circuitry coupled to a multi-touch display to implement a method, the method comprising:
displaying an inspection tool for a chart on a user interface on the multi-touch display, the inspection tool comprising a multiplier-scale control and a precision control;
determining a base level of scaling to apply to the chart based on a current value of the multiplier-scale control, the multiplier-scale control defining steps between multiplier-scaling values;
detecting a touch-based input on the precision control for a precision adjustment of the chart, the precision adjustment based on linear steps dynamically defined with respect to the base level of scaling; and
adjusting the chart in response to the touch-based input on the precision control as a combination of the base level of scaling determined by the multiplier-scale control and the precision adjustment of the precision control.

17. The computer program product according to claim 16, further comprising:
displaying the precision control as a dial control on the inspection tool; and
displaying the multiplier-scale control as a slider control on the inspection tool.

18. The computer program product according to claim 17, further comprising:
displaying the slider control as a series of discrete steps each configured to adjust the base level of scaling of the chart; and
detecting adjustments to the base level of scaling in response to a touch-based input on the slider control.

19. The computer program product according to claim 17, further comprising:
positioning the dial control and the slider control in closely spaced proximity to support applying touch-based inputs to the dial control and the slider control using a same user hand at about a same time.

20. The computer program product according to claim 16, further comprising:
determining a position of the inspection tool;
defining the inspection tool as a zoom control based on determining that the inspection tool is positioned on a data display portion of the chart; and
dynamically redefining the inspection tool as a pan control based on determining that the inspection tool is positioned on an axis of the chart.
